(19) United States
(12) Patent Application Publication
(10) Pub. No.: US 2024/0141900 A1
(43) Pub. Date: May 2, 2024

(54) VERTICALLY SUSPENDED CENTRIFUGAL PUMP WITH INTEGRAL SPEED REDUCER

(71) Applicant: CPC Pumps International, Burlington (CA)

(72) Inventor: Zhengwang Li, Burlington (CA)

(21) Appl. No.: 18/498,602

(22) Filed: Oct. 31, 2023

Related U.S. Application Data
(60) Provisional application No. 63/421,363, filed on Nov. 1, 2022.

(51) Int. Cl. F04D 13/02; F04D 1/08

(52) U.S. Cl. CPC F04D 13/028; F04D 1/08; F04D 13/022

(57) ABSTRACT

A vertically suspended centrifugal pump including a speed reducing system disposed between a first shaft and a second shaft to allow a speed differential between the first shaft and the second shaft.

### CROSS-REFERENCE TO RELATED APPLICATIONS

This application claims priority to U.S. Provisional Application Ser. No. 63/421,363, having a filing date of Nov.1, 2022, the entire contents of which are hereby incorporated by reference.

### FIELD OF TECHNOLOGY

The following relates to embodiments of a vertically suspended centrifugal pump, and more specifically to embodiments of a vertically suspended centrifugal pump with an integral speed reducer.

### BACKGROUND

For vertically suspended a centrifugal pump to work properly, there must be sufficient Net Positive Suction Head (NPSH) margin (NPSH available—NPSH required). NPSH available is determined by a pumping system while NPSH required is a parameter of a centrifugal pump design.

### SUMMARY

An aspect relates to a vertically suspended centrifugal pump comprising: a speed reducing system disposed between a first shaft and a second shaft to allow a speed differential between the first shaft and the second shaft.

In an exemplary embodiment, the vertically suspended centrifugal pump includes a first stage operably coupled to the second shaft, a second stage operably coupled to the first shaft, and a third stage or more operably coupled to the main shaft. During an operation of the vertically suspended centrifugal pump, the first stage runs at a lower speed than the second stage as a function of the speed differential between the first shaft and the second shaft. As an example, during the operation of the vertically suspended centrifugal pump, the second stage is an impeller with a running speed at or above 3600 rpm.

Another aspect relates to a vertically suspended centrifugal pump comprising: a main shaft being driven at a first speed, a plurality of series stage impellers coupled to the main shaft, a speed reducing system comprising: a first pinion operably connected to the main shaft, configured to rotate at the first speed, a first set of gears meshed with the first pinion, configured to rotate at a second speed that is reduced from the first speed, a second set of gears meshed with a second pinion, configured to rotate at the second speed, a secondary shaft operably coupled to the second pinion of the speed reducing system, configured to rotate at the second speed, and a first stage impeller coupled to the secondary shaft.

The reduced speed is reduced by a ratio between the first pinion and the first set of gears. In an exemplary embodiment, the first set of gears are larger than the second set of gears. The vertically suspended centrifugal pump with the spur gear system minimizes a net positive suction head required of the first stage impeller by running at the second speed while the plurality of series stage impellers run at the first speed, for example, is at or above 3600 rpm.

Another aspect relates to a vertically suspended centrifugal pump comprising: a main shaft being driven at a first speed, a plurality of series stage impellers coupled to the main shaft, a speed reducing system comprising: a star gear operably connected to the main shaft, configured to rotate at the first speed, at least one planetary gear meshed with the star gear and a stationary gear, the at least one planetary gear configured to rotate at a second speed that is reduced from the first speed, and a carrier coupled to the at least one planetary gear, configured to rotate at the second speed, a secondary shaft operably coupled to the carrier, configured to rotate at the second speed, and a first stage impeller coupled to the secondary shaft.

The vertically suspended centrifugal pump with the planetary gear system also minimizes a net positive suction head required of the first stage impeller is minimized by running at the second speed while the plurality of series stage impellers run at the first speed, for example, at 3600 rpm.

Another aspect relates to a method comprising: disposing a speed reducing system between two separate shafts of a vertically suspended centrifugal pump to allow a speed differential between the two separate shafts. As a function of disposing the speed reducing system between two separate shafts, a net a net positive suction head of a first stage impeller coupled to one of the two separate shafts is minimized by running at a lower speed than a plurality of series stage impellers coupled to the other of the two separate shafts.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1A depicts a first type of conventional, vertically suspended centrifugal pump including a single, main shaft vertically extending through the pump;

FIG. 1B depicts a second type of conventional, vertically suspended centrifugal pump including a single, main shaft vertically extending through the pump;

FIG. 2 schematically depicts a pump having a speed reducing system disposed between two separate shafts, in accordance with embodiments of the present invention;

FIG. 3A depicts a detailed embodiment of a vertically suspended centrifugal pump having a first type of speed reducing system, in accordance with embodiments of the present invention;

FIG. 3B depicts a detailed embodiment of a vertically suspended centrifugal pump having a second type of speed reducing system, in accordance with embodiments of the present invention;

FIG. 4 depicts the speed reducing system of the pump depicted in FIG. 3A, highlighted by section A, in accordance with embodiments of the present invention;

FIG. 5 depicts the speed reducing system of the pump depicted in FIG. 3b, highlighted by section A, in accordance with embodiments of the present invention;

FIG. 6 schematically depicts a pump having a speed reducing system disposed between two separate shafts at a different location than the pump of FIG. 2, in accordance with embodiments of the present invention; and

FIG. 7 schematically depicts a pump having more than one speed reducing system disposed, in accordance with embodiments of the present invention.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

In brief overview, it is desirable to minimize NPSH required of a centrifugal pump. NPSH available, usually expressed in liquid column height, is an amount of pressure that is above a vapor pressure of a pumping liquid at a pump's suction. Referencing to a certain datum point (i.e. a pump's suction nozzle), NPSH available of a pumping system can be as low as zero (i.e., the pumping liquid is at bubbling point). NPSH required is related to an impeller design, a flowrate, and a running speed. NPSH required (NPSHR) can be expressed as:

$$N P S H {R}^{3 / 4} = \frac{\sqrt{Q} n}{N s s}$$

where, NPSHR is Net Positive Suction Head required in feet, Q is flowrate in gpm, Nₛₛ is suction specific speed, and n is running speed in rpm. The lowest achievable NPSH required is such that the resulting suction specific speed is in a reasonable range; a practical range is up to 13,000 in US customary units, though 18,000 or even higher is possible.

In the oil and gas industry, for applications where NPSH available is low and differential head is high, vertically suspended multi-stage pumps (e.g. API 610 VS1 or VS6 pumps) are typically used because a first stage impeller resides below grade and a pump could provide NPSH available to the first stage impeller so that sufficient NPSH margin can be obtained for the selected pumps to work properly. Conventional vertically suspended multi-stage pumps adopt one or more of the below measures to obtain needed NPSH margin: a high suction specific speed first stage impeller; an inducer before the first stage impeller; a double-suction first stage impeller; extra-long shafts (extra-long pumps) for obtaining needed NPSHA; and running the entire pump at a lower speed relative to the design speed.

Each of these measures have drawbacks. For example, high suction specific speed impellers (Nss>13,000) and inducers tend to generate “U” shaped NPSHR curves and cause internal recirculation, which narrows an operating range. Using a double suction first stage impeller, the reduction in NPSHR over with a single suction first stage impeller is limited to a factor of 2^{2/3}. Using an extra-long shaft tends to cause rotor dynamic issues and reliability issues in addition to high costs. Running the entire pump at a lower speed can reduce NPSHR by a factor of (n₂n₁)^{4/3}; however, it would require a larger pump, or increase a number of stages by a factor of (η₂/η₁)² to meet differential head requirement, which inevitably increases costs.

Another method to reduce NPSHR is to lower the running speed when Nss and Q are kept constant. To slow down the entire pump is not desirable. If the first stage impeller and the series stage impellers can run at different speeds (i.e., the first stage impeller running at a lower speed for low NPSHR while the series stage impellers running at a higher speed for required total differential head), it would not only produce low NPSHR but also a high total differential head.

Embodiments of the present invention minimize NPSHR of a first stage (e.g. first stage impeller) by running the first stage at an optimized lower speed than the other stages of the centrifugal pump using an integral speed reducer. The integral speed reducer is a speed reducing system disposed between and connected to two separate shafts of the centrifugal pump to allow for a speed differential between the two separate shafts. For example, one or more impellers coupled to a main shaft being driven at a first speed (e.g. high-speed) can run at a higher speed than an impeller coupled to a secondary shaft, which runs at a lower speed (e.g. low-speed). The use of the speed reducing system also minimizes an overall pump length by generating low NPSHR or sufficient NPSH margin and optimizes a suction specific speed so that the pump can run in a wide range of flowrate. With a first stage impeller running at a low speed, the series stage impeller(s) can run at a speed at or above 3600 rpm for optimized efficiency, further reducing the length of the pump. In exemplary embodiments, the speed reducing system employs a spur gear system or an epicyclic gear system between the first stage and the second stage impellers of the centrifugal pump so that the first stage impeller can run at a different speed than the series stage impellers. In another exemplary embodiment, the speed reducing system uses a hydraulic coupling speed reducer between the first stage and second stage impellers of the centrifugal pump so that the first stage impeller can run at a different speed than the series stage impellers.

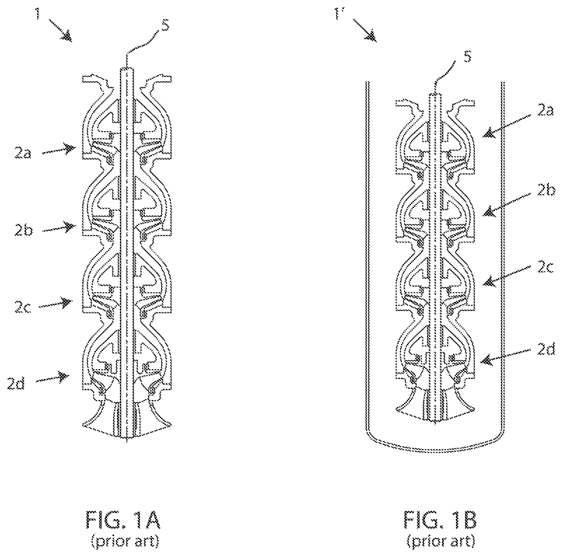

Referring now to FIGS. 1A and 1B, conventional vertically suspended centrifugal pumps include a single, main shaft 5 vertically extending through the pump 1, 1′. The pump 1, 1′ are multiple stage pumps, including a first stage, a second stage, a third stage, and a fourth stage. Each stage involves an impeller 2a, 2b, 2c, 2d coupled to the main shaft 5. As the main shaft 5 is driven, for example, caused to be rotated, each of the impellers 2a, 2b, 2c, 2d are caused to rotate at the same speed. In other words, the impeller 2a of the first stage rotates at the same speed as the other series impellers 2b, 2c, 2d when the main shaft 5 is driven by a driver (not shown).

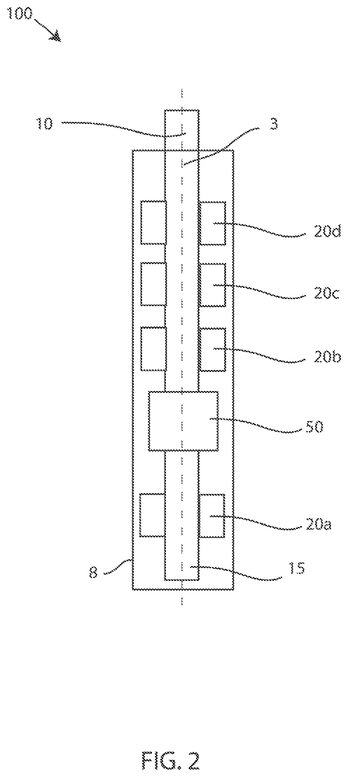

FIG. 2 schematically depicts a pump 100 having a speed reducing system 50 disposed between two separate shafts 10, 15, in accordance with embodiments of the present invention. Pump 100 is a vertically suspended centrifugal pump that can be used for applications in oil and gas, petrochemical, chemical, liquid carbon dioxide, and liquid hydrogen. In an exemplary embodiment, the pump 100 is a vertically suspended centrifugal pump having two vertically oriented shafts 10, 15 sharing a common longitudinally extending rotation axis 3. The pump 100 includes a housing 8 that is configured to enclose or at least partially enclose the components of the pump 100. The pump 100 includes multiple stages 20a, 20b, 20c, 20d. Stages 20a, 20b, 20c, 20d can be an impeller, rotor, or any rotating component used for accelerating fluids through the pump 100. While four stages are depicted in the illustrated embodiment, the pump 100 may include two, three, or more than four stages. Stage 20a is coupled to secondary shaft 15 while the remaining stages 20b, 20a, 20c, 20d are coupled to the main shaft 10. For instance, a stage 20a, 20b, 20c, 20d may be mounted, directly or otherwise, to the shafts 10, 15.

Moreover, the pump 100 includes a speed reducing system 50 to allow for a speed differential between the main shaft 10 and the secondary shaft 15 so that the stage 20a (e.g. first stage) can be operated at a different (e.g. lower) speed than the other stages 20b, 20c, 20d. The speed differential between the shafts 10, 15 minimizes net positive suction head and allows for a smaller length of the overall pump 100. The speed reducing system 50 is disposed between the main shaft 10 and secondary shaft 15. For example, an end of the main shaft 10 is attached to a component of the speed reducing system 50, such as a pinion or epicyclic gear, and an end of the secondary shaft 15 is also attached to a component of the speed reducing system 50. In some embodiment, the end of the main shaft 10 and/or the end of the secondary shaft 15 is structurally integral with components of the speed reducing system 50.

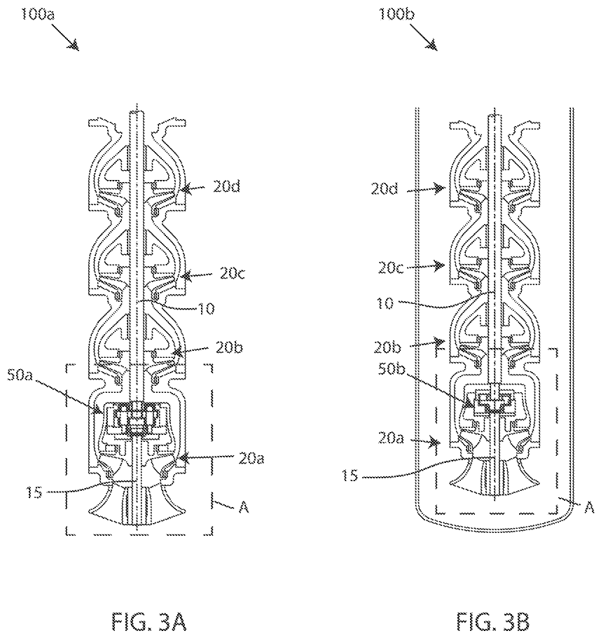

FIGS. 3A and 3B depict more detailed embodiments of vertically suspended centrifugal pumps 100a, 100b, respectively, having a speed reducing system 50a, 50b, in accordance with embodiments of the present invention. Instead of a single main shaft, the pump 100a, 100b include a main shaft 10 (e.g. first shaft) and a secondary shaft 15 (e.g. second shaft). The speed reducing system 50a, 50b is disposed between the main shaft 10 and the second shaft 15, operably connected to both shafts 10, 15. The pump 100a, 100b includes multiple pump stages, including a first pump stage, a second pump stage, a third pump stage, and a fourth pump stage. While four stages are depicted in the illustrated embodiment, the pump 100a, 100b may include two, three, or more than four stages of impellers. The series pump stage involves impellers 20a, 20b, 20c, 20d but the first stage impeller 20a is coupled to the secondary shaft 15 while the series stage impellers 20b, 20c, 20d are coupled to the main shaft 10. As the main shaft 10 is driven, for example, caused to be rotated, the impellers associated with series pump stages after the first pump stage (e.g. impellers 20b, 20c, 20d) are caused to rotate at the same speed. Because of the integral speed reducing system 50a, 50b, the secondary shaft 15 rotates at a reduced speed from the speed of the main shaft 10. As a result, the first stage impeller 20a of the first pump stage rotates at a different (e.g. lower) speed than the other series impellers 20b, 20c, 20d when the main shaft 1 is driven by a driver (not shown). Thus, there is a speed differential between the two separate shafts 10, 15.

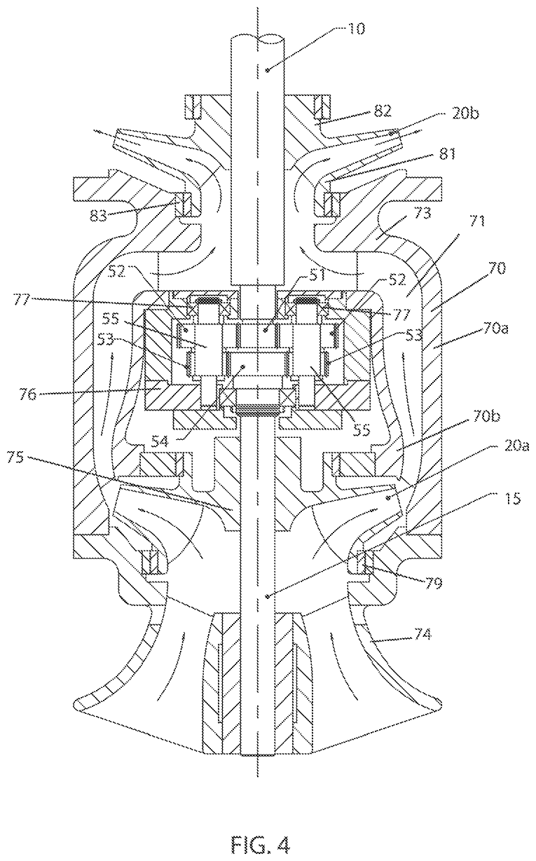

FIG. 4 depicts the speed reducing system 50a of the pump 100a depicted in FIG. 3A, highlighted by section A, in accordance with embodiments of the present invention. The speed reducing system 50a is a gear system used for creating a speed differential between the main shaft 10 and the second shaft 15. In an exemplary embodiment, the speed reducing system 50a is a spur gear system. The speed reducing system 50a includes a first pinion 51, a first set of gears 52, a second set of gears 53, and a second pinion 54. The first pinion 51, the first set of gears 52, the second set of gears 53, and the second pinion 54 each include teeth along outer, circumferential surfaces. The gear teeth may have various spacing, thickness, pitch, size, and the like. Similarly, a size of the first pinion 51, the first set of gears 52, the second set of gears 53, and the second pinion 54 may vary to accomplish different desired speeds, ratios, torque transmission, and the like, of the speed reducing system 50a.

The first pinion 51 is operably connected to the main shaft 10. For example, the first pinion 51 may be mounted to the main shaft 10 so that rotation of the main shaft 10 translates to rotation of the first pinion 51, or vice versa. In other embodiments, the first pinion 51 may be structurally integral with the main shaft 10. The first pinion 50a rotates at the speed of the main shaft 10 (e.g. first speed) as the main shaft 10 is driven. A first set of gears 52 mesh with the first pinion 51 such that rotation of the first pinion 51 causes rotation of the first set of gears 52. The first set of gears 52 rotate at a reduced speed (e.g. second speed) that is reduced from the first speed. The reduced speed is reduced by a ratio between the first pinion 51 and the first set of gears 52. A second set of gears 53 share pinion shafts 55 with the first set of gears 52 so that the second set of gears 53 rotate at the reduced rotation speed of the first set of gears 52. The second set of gears 53, which are smaller than the first set of gears 52, mesh with a second pinion 54 such that rotation of the second set of gears 53 causes rotation of the second pinion 54. The second pinion 54 rotates at the reduced speed. Because the secondary shaft 15 is operably coupled to the second pinion 54, the second shaft 15 rotates at the reduced speed and thus at a different speed than the main shaft 10. For example, the second pinion 54 may be mounted to the secondary shaft 10 so that rotation of second pinion 54 translates to rotation of the secondary shaft 15, or vice versa. In other embodiments, the second pinion 54 may be structurally integral with the secondary shaft 15. A first stage, such an impeller, is coupled to the secondary shaft 15. The arrows depict a flow path of a fluid through the pump.

Moreover, the speed reducing system 50a is housed within a diffuser 70. The diffuser 70, also referred to as a bowl, includes an outer diffuser portion 70a and an inner diffuser portion 70b. The space between the outer diffuser portion 70a and the inner diffuser portion 70b is a passage 71 that allows a fluid to flow through the pump to the next stage of the pump. A vane or blade is positioned between the outer diffuser portion 70a and the inner diffuser portion 70b in a spiral or helical pattern to structurally couple the outer diffuser portion 70a and the inner diffuser portion 70b as well as guide the flow of fluid around the inner diffuser portion 70b in a spiral or helical pattern towards the next stage. Various structural configurations of the vane or blade and/or bowl configurations can be used along with the speed reducing system 50a. The outer diffuser portion 70a is a generally annular member having a shoulder 73 in which an outer diameter of the diffuser 70 is reduced compared with a remaining body portion of the diffuser 70.

The speed reducing system 50a resides within the inner diffuser portion 70b proximate the longitudinal axis of the pump 100. A cartridge assembly 76 is disposed between the inner diffuser portion 70b and the speed reducing system 50a. The cartridge assembly 76 may comprise a single structure or may be comprised of a plurality of components fastened together to form the cartridge 76. Radial bearings 77 are disposed between the cartridge 76 and the speed reducing system 50a to allow for rotation of the pinion shafts 55 with respect to the cartridge 76.

The diffuser 70 is stationary with respect to other components of the pump 100.

The diffuser 70 shown in FIG. 4 is attached to a suction bell 74 in which the fluid is drawn into the diffuser 70. In an exemplary embodiment, the diffuser 70 is fixedly attached to the suction bell 74 via one or more fasteners, such as a bolt or similar fastener. The diffuser 70 is operably connected to a hub 75 of the impeller 20a of the stage shown in FIG. 4 (i.e. first stage). A wear ring 79 is disposed between the hub 75 and the diffuser 70. The impeller 20a is mechanically coupled to the main shaft 15 and rotates with the secondary shaft 15 while the suction bell 74 and the diffuser 70 remain stationary. The rotation of the impeller 20a draws the fluid through the suction bell 74 and into the diffuser 70, specifically, the passage 71 between the outer diffuser portion 70a and the inner diffuser portion 70b.

The diffuser 70 is operably coupled to the second stage impeller 20b proximate the shoulder 73 of the diffuser 70. The second stage impeller 20b includes a front shroud 81 and a back shroud 82. A wear ring 83 is disposed between the front shroud 81 of the second stage impeller 20b and the diffuser 70 of the first stage. Fluid that flows through the passage 71 of the diffuser 70 is further drawn into the second stage impeller 20 due to the rotation of the second stage impeller 20b caused by the mechanical coupling of the second stage impeller 20b to the main shaft 10. The second stage impeller 20b rotates at a different speed than the first stage impeller 20a as a result of the speed reducing system 50.

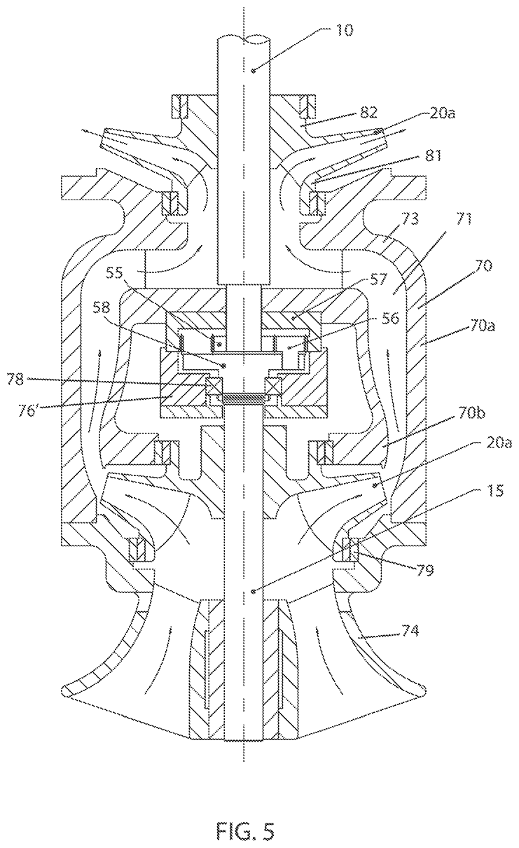

FIG. 5 depicts the speed reducing system 50b of the pump 100b depicted in FIG. 3b, highlighted by section A, in accordance with embodiments of the present invention. The speed reducing system 50b is a gear system used for creating a speed differential between the main shaft 10 and the second shaft 15. In an exemplary embodiment, the speed reducing system 50b is a planetary or epicyclic gear system. The speed reducing system 50b includes a star gear 55, a planetary gear 56, a stationary gear 57 and a carrier 58. The star gear 55, the planetary gear 56, and the stationary gear 57 each include teeth along outer, circumferential surfaces. The gear teeth may have various spacing, thickness, pitch, size, and the like. Similarly, a size of the star gear 55, the planetary gear 56, and the stationary gear 57 may vary to accomplish different desired speeds, ratios, torque transmission, and the like, of the speed reducing system 50b.

The star gear 55 is operably connected to the main shaft 10. The star gear 55 rotates at the speed as the main shaft 10 (e.g. first speed) as the main shaft 10 is driven. At least one planetary gear 56 meshes with the star gear 55 and the stationary gear 57; the planetary gear 56 rotates at a reduced speed (e.g. second speed) that is reduced from the first speed. The carrier 58 is coupled to the at least one planetary gear 56 such that rotation of the planetary gear 56 causes a rotation of the carrier 58, which also rotates at the reduced speed. Because the secondary shaft 15 is operably coupled to the carrier 58, the secondary shaft 15 rotates at the reduced speed and thus at a different speed than the main shaft 10. A first stage, such an impeller, is coupled to the secondary shaft 15. The arrows depict a flow path of a fluid through the pump.

Moreover, the speed reducing system 50b is housed within the diffuser 70. The diffuser 70, also referred to as a bowl, includes the outer diffuser portion 70a and the inner diffuser portion 70b. The space between the outer diffuser portion 70a and the inner diffuser portion 70b is a passage 71 that allows a fluid to flow through the pump to the next stage of the pump. A vane or blade is positioned between the outer diffuser portion 70a and the inner diffuser portion 70b in a spiral or helical pattern to structurally couple the outer diffuser portion 70a and the inner diffuser portion 70b as well as guide the flow of fluid around the inner diffuser portion 70b in a spiral or helical pattern towards the next stage. Various structural configurations of the vane or blade and/or bowl configurations can be used along with the speed reducing system 50b. The outer diffuser portion 70a is a generally annular member having a shoulder 73 in which the outer diameter of the diffuser 70 is reduced compared with a remaining body portion of the diffuser 70.

The speed reducing system 50b resides within the inner diffuser portion 70b proximate the longitudinal axis of the pump 100. A cartridge assembly 76′ is disposed between the inner diffuser portion 70b and the speed reducing system 50b. The cartridge assembly 76′ may comprise a single structure or may be comprised of a plurality of components fastened together to form the cartridge 76′. Bearing 78 is disposed between the cartridge 76′ and the carrier 58 to allow for rotation of the carrier 59 with respect to the cartridge 76′.

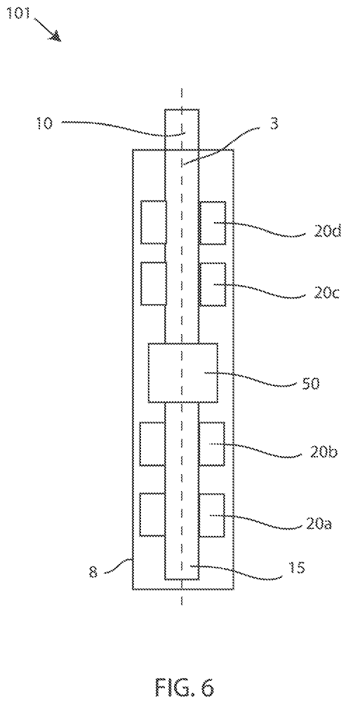

The diffuser 70 is stationary with respect to other components of the pump 100. The diffuser 70 shown in FIG. 6 is attached to a suction bell 74 in which the fluid is drawn into the diffuser 70. In an exemplary embodiment, the diffuser 70 is fixedly attached to the suction bell 74 via one or more fasteners, such as a bolt or similar fastener. The diffuser 70 is operably connected to the hub 75 of the impeller 20a of the stage shown in FIG. 5 (i.e. first stage). A wear ring 79 is disposed between the hub 75 and the diffuser 70. The impeller 20a is mechanically coupled to the main shaft 15 and rotates with the secondary shaft 15 while the suction bell 74 and the diffuser 70 remain stationary. The rotation of the impeller 20a draws the fluid through the suction bell 74 and into the diffuser 70, specifically, the passage 71 between the outer diffuser portion 70a and the inner diffuser portion 70b.

The diffuser 70 is operably coupled to the second stage impeller 20b proximate the shoulder 73 of the diffuser 70. The second stage impeller 20b includes a front shroud 81 and a back shroud 82. A wear ring 83 is disposed between the front shroud 81 of the second stage impeller 20b and the diffuser 70 of the first stage. Fluid that flows through the passage 71 of the diffuser 70 is further drawn into the second stage impeller 20 due to the rotation of the second stage impeller 20b caused by the mechanical coupling of the second stage impeller 20b to the main shaft 10. The second stage impeller 20b rotates at a different speed than the first stage impeller 20a as a result of the speed reducing system 50.

FIG. 6 schematically depicts a pump 101 having a speed reducing system 50 disposed between two separate shafts at a different location than the pump 100 of FIG. 2, in accordance with embodiments of the present invention. Pump 101 shares the same structure and function of the pump 101 in FIG. 2, except that the speed reducing system 50 is located between the second stage 20b and the third stage 20c. For instance, stage 20a and stage 20b are mounted to the secondary shaft 15, and stage 20c and stage 20d are mounted to the main shaft 10. The speed reducing system 50 allows for a speed differential between the main shaft 10 and the secondary shaft 15 so that the stages 20a and 20b can be operated at different (e.g. lower) speeds than the other stages 20c, 20d. The speed differential between the shafts 10, 15 minimizes net positive suction head and allows for a smaller length of the overall pump 101. The speed reducing system 50 is disposed between the main shaft 10 and secondary shaft 15. For example, an end of the main shaft 10 is attached to a component of the speed reducing system 50, such as a pinion or epicyclic gear, and an end of the secondary shaft 15 is also attached to a component of the speed reducing system 50. In some embodiments, the end of the main shaft 10 and/or the end of the secondary shaft 15 is structurally integral with components of the speed reducing system 50.

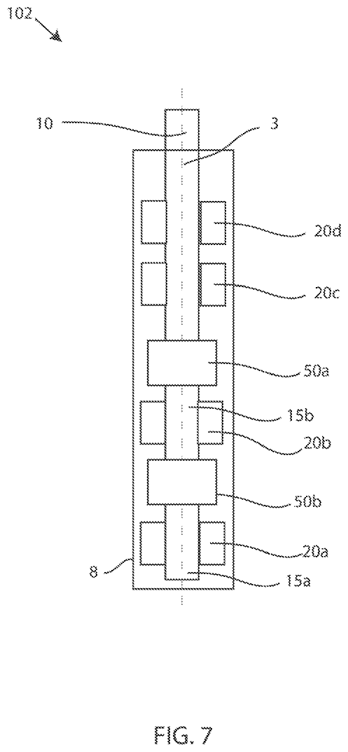

FIG. 7 schematically depicts a pump 102 having more than one speed reducing system disposed, in accordance with embodiments of the present invention. Pump 102 shares the same structure and function of the pump 101 in FIG. 2, except that pump 102 includes two speed reducing systems 50a, 50b. The first speed reducing system 50a is located between the first stage 20a and the second stage 20b, and the second speed reducing system 50b is located between the second stage 20b and the third stage 20c. For instance, stage 20a is mounted to a first secondary shaft 15a, stage 20b is mounted to a second secondary shaft 15b, and stage 20c and stage 20d are mounted to the main shaft 10. An end of the main shaft 10 is attached to a component of the speed reducing system 50b, such as a pinion or epicyclic gear, and an end of the second secondary shaft 15b is also attached to a component of the speed reducing system 50bm, such as a pinion or epicyclic gear. The opposing end of the second secondary shaft 15b is attached to the speed reducing system 50a, such as a pinion or epicyclic gear, and an end of the first secondary shaft 15a is also attached to the speed reducing system 50a, such as a pinion or epicyclic gear. In some embodiments, the ends of the main shaft 10 and/or the ends of the secondary shafts 15a, 15b are structurally integral with components of the speed reducing system 50a, 50b, respectively.

The speed reducing system 50a allows for a speed differential between the first secondary shaft 15a and the second secondary shaft 15b so that the stages 20a can be operated at a different (e.g. lower) speed than stage 20b and also at a different speed than the other stages 20c, 20d. The speed reducing system 50b allows for a speed differential between the second secondary shaft 15b and the main shaft 10 so that the stages 20b can be operated at a different (e.g. lower) speed than stage 20a and also at a different speed than the other stages 20c, 20d. The speed differential between the shafts 10, 15a, 15b minimizes net positive suction head and allows for a smaller length of the overall pump 102.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. A vertically suspended centrifugal pump comprising:
a speed reducing system disposed between a first shaft and a second shaft to allow a speed differential between the first shaft and the second shaft.

2. The vertically suspended centrifugal pump according to claim 1, further comprising a first stage operably coupled to the second shaft.

3. The vertically suspended centrifugal pump according to claim 2, further comprising a second stage operably coupled to the first shaft.

4. The vertically suspended centrifugal pump according to claim 3, wherein, during an operation of the vertically suspended centrifugal pump, the first stage runs at a lower speed than the second stage as a function of the speed differential between the first shaft and the second shaft.

5. The vertically suspended centrifugal pump according to claim 6, wherein, during the operation of the vertically suspended centrifugal pump, the second stage is an impeller with a running speed above at or 3600 rpm.

6. The vertically suspended centrifugal pump according to claim 1, further comprising a third stage and a fourth stage operably coupled to the first shaft.

7. The vertically suspended centrifugal pump according to claim 1, wherein the speed reducing system is a spur gear system.

8. The vertically suspended centrifugal pump according to claim 1, wherein the speed reducing system is a planetary gear system.

9. The vertically suspended centrifugal pump according to claim 1, wherein the speed reducing system is a hydraulic coupling speed reducer.

10. A vertically suspended centrifugal pump comprising:
a main shaft being driven at a first speed;
a plurality of series stage impellers coupled to the main shaft;
a speed reducing system comprising:
a first pinion operably connected to the main shaft, configured to rotate at the first speed,
a first set of gears meshed with the first pinion, configured to rotate at a second speed that is reduced from the first speed,
a second set of gears meshed with a second pinion, configured to rotate at the second speed;
a secondary shaft operably coupled to the second pinion of the speed reducing system, configured to rotate at the second speed; and
a first stage impeller coupled to the secondary shaft.

11. The vertically suspended centrifugal pump according to claim 10, wherein the reduced speed is reduced by a ratio between the first pinion and the first set of gears.

12. The vertically suspended centrifugal pump according to claim 10, wherein the first set of gears are larger than the second set of gears.

13. The vertically suspended centrifugal pump according to claim 10, wherein a net positive suction head of the first stage impeller is minimized by running at the second speed while the plurality of series stage impellers run at the first speed.

14. The vertically suspended centrifugal pump according to claim 10, wherein the first speed is at or above 3600 rpm.

15. A vertically suspended centrifugal pump comprising:
a main shaft being driven at a first speed;
a plurality of series stage impellers coupled to the main shaft;
a speed reducing system comprising:
a star gear operably connected to the main shaft, configured to rotate at the first speed,
at least one planetary gear meshed with the star gear and a stationary gear, the at least one planetary gear configured to rotate at a second speed that is reduced from the first speed, and
a carrier coupled to the at least one planetary gear, configured to rotate at the second speed;
a secondary shaft operably coupled to the carrier, configured to rotate at the second speed; and
a first stage impeller coupled to the secondary shaft.

16. The vertically suspended centrifugal pump according to claim 15, wherein a net positive suction head of the first stage impeller is minimized by running at the second speed while the plurality of series stage impellers run at the first speed.

17. The vertically suspended centrifugal pump according to claim 15 wherein the first speed is at or above 3600 rpm.

18. A method comprising:
disposing a speed reducing system between two separate shafts of a vertically suspended centrifugal pump to allow a speed differential between the two separate shafts.

19. The method of claim 18, wherein, as a function of the speed reducing system, a net a net positive suction head of a first stage impeller coupled to one of the two separate shafts is minimized by running at a lower speed than a plurality of series stage impellers coupled to the other of the two separate shafts.
